(19) United States
(12) Patent Application Publication
(10) Pub. No.: US 2012/0211500 A1
(43) Pub. Date: Aug. 23, 2012

(54) Cup with Thermal Guard and Method for Use Thereof

(75) Inventor: Scott L. Amron, Smithtown, NY (US)

(73) Assignee: THUNK IT, LLC, Westbury, NY (US)

(21) Appl. No.: 13/360,507

(22) Filed: Jan. 27, 2012

Related U.S. Application Data
(63) Continuation-in-part of application No. 12/932,568, filed on Feb. 28, 2011, now abandoned.
(60) Provisional application No. 61/308,642, filed on Feb. 26, 2010.

(51) Int. Cl. B65D 81/38; B65D 25/36; C09D 127/08; B32B 3/10; B32B 5/16; B65D 25/34; B65D 85/72

(52) U.S. Cl. 220/592.16; 220/592.22; 206/459.5; 206/459.1; 428/195.1; 521/145

(57) ABSTRACT

A container for hot liquids includes a thermal barrier printed on a surface thereof. The thermal barrier includes a plurality of expandable microspheres that expand when exposed to heat to increase thermal insulation. During shipping and pre-use, the thermal barrier is not activated. Exposure to heat from a hot liquid poured in the container activates the microspheres, which expand to increase thermal insulation properties, thereby allowing a user to hold the cup without being too hot to the touch.

### CROSS-REFERENCE TO RELATED APPLICATIONS

The present application is a Continuation-in-Part of U.S. patent application Ser. No. 12/932,568, filed Feb. 28, 2011, which claims the benefit of Provisional Application No. 61/308,642, filed on Feb. 26, 2010.

### BACKGROUND OF THE INVENTION

1. Field of the Invention

The present invention relates to a thermal guard for use with a hot beverage container and a method using the thermal guard.

2. Description of the Related Art

A common practice for hot beverage containers is to use a protective sleeve to protect a user from the heat of the liquid in the cup and allow a user to comfortably hold the container. This practice us used, for example, when the container is a disposable coffee or tea cup, because these types of cups typically provide little thermal shielding by themselves. In most cases, the shield is made of corrugated cardboard, or other material such as plastic, and is sized to fit over the cup. The sleeves are designed to universally fit over a wide variety of cup sizes and therefore can result in a poor fit. Further, the universal design offers little efficiency with respect to material usage and ease of use. The cups and sleeves are typically shipped separately. The use of the sleeves does provide increased thermal protection. However, it is inconvenient to mate the sleeve and cup manually at the point of sale. Furthermore, the sleeves are purchased separately and represent an added expense both fiscally and environmentally. If sleeves are not available, it is also common for a user or a seller to use two disposable cups to provide adequate insulation. The practice of double-cupping is a waste of materials. If the cups are made thicker, more material is used and also increases the volume required when shipping, therefore increasing the cost of the cups in these two ways.

### SUMMARY OF THE INVENTION

It is an object of the present invention to provide a cup that avoids the problems of the prior art.

It is also an object of the present invention to provide a cup that uses as little material as possible to provide the desired thermal protection.

According to one embodiment of the present invention, a cup has a thickness that increases when exposed to a hot liquid content, thereby having a relatively thinner thickness during shipping and storage before use and increases in thickness to provide adequate insulation during use.

According to another embodiment of the present invention, a food or beverage container for hot or cold food or liquid with a thermal barrier that is substantially flat on a surface of the container and expands to enhance thermal insulation properties when the thermal barrier is exposed to a change in temperature. More particularly, the thermal barrier expands in response the introduction of hot or cold contents into the container. In a further embodiment, the thermal barrier returns to a flattened state when the hot or cold temperature is removed.

Coffee cups can get very hot to the touch, which is why some people use two cups, i.e., double cup, or alternatively place cardboard sleeves around cups to keep from getting burned. The present invention obviates both the need for sleeves and the use of two cups, thereby reducing material and shipping costs. According to the invention, pouring a hot beverage such as, for example, coffee, tea, hot chocolate, or soup into the inventive cup causes a section of the container walls to swell to form an insulating collar around the container. The inventive cup is thin prior to activation and can be stacked. The collar is formed by an endothermic reaction. The collar may be arranged to absorb heat from the contents of the container to reduce the temperature of the contents of the container.

The thermal barrier is made of expandable microspheres that expand when exposed to heat. These microspheres may comprise part of an ink that is printed onto the exterior of the container. The microspheres expand to a different degree as a function of the type of substrate they are applied onto. A pattern or design may be printed on a container using conventional printing or coating methods. The expandable ink of the present invention is then applied as a coating over the pattern or design. Upon expansion of the expandable ink with the microspheres, the logo or other pattern will appear in three-dimensional form.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings, wherein like reference characters denote similar elements throughout the several views:

FIG. 1 is a perspective view of a container according to an embodiment of the present invention in an unused state;

FIG. 2 is a perspective view of the container of FIG. 1 after a hot beverage is poured therein;

FIG. 3 is a perspective view of another embodiment of the present invention;

FIG. 4 is a cross-section of a wall of a container according to another embodiment of the present invention;

FIG. 5 is a cross section of a wall of the container of FIG. 1;

FIG. 6 is a cross section of a wall of the container of FIG. 2;

FIG. 7 is a detail of the container of FIG. 5;

FIG. 8 is a perspective view of a container according to another embodiment of the present invention prior to application of a thermal barrier;

FIG. 9 is a perspective view of the container of FIG. 8 with a barrier according to one embodiment;

FIG. 10 is a perspective view of the container of FIG. 8 with a barrier according to another embodiment;

FIG. 11 is a perspective view of a container with a barrier layer according another embodiment of the present invention;

FIG. 12 is a perspective view of a container with a barrier layer according to yet another embodiment of the present invention;

FIG. 13 is a cross section of a container wall according to an embodiment of the present invention;

FIG. 14 is a perspective view of a container according to an embodiment of the present invention prior to application of a barrier layer; and

FIG. 15 is a perspective view of the container of FIG. 14 after the barrier layer is applied.

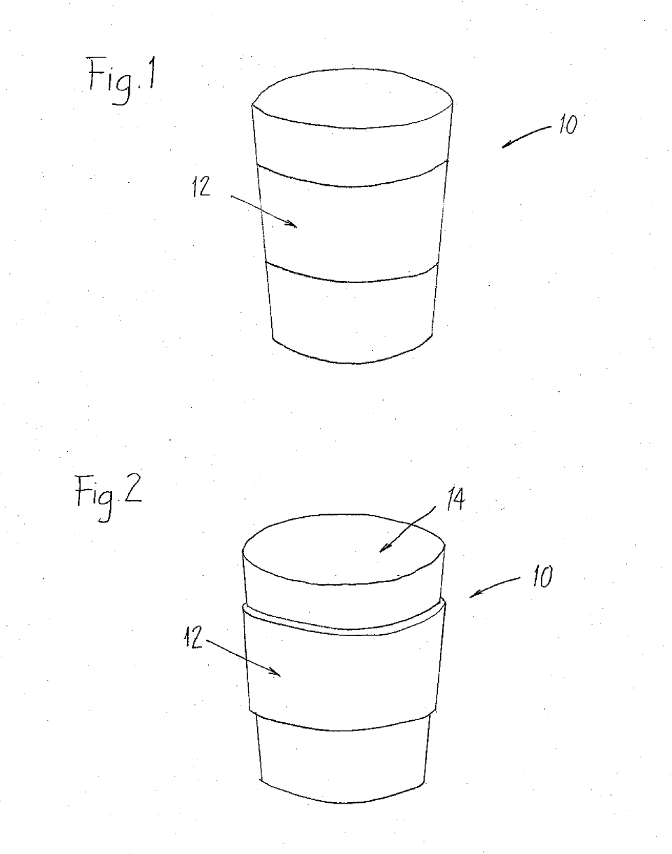

### DETAILED DESCRIPTION OF THE PRESENTLY EMBODIMENTS

FIG. 1 illustrates an embodiment of a cup 10 including a thermal barrier 12 as a band around the cup. The thermal barrier 12 of this embodiment is uniform in width and thickness. The cup 10 is preferably a paper or cardboard cup, but can also be any known or hereafter developed material for holding a hot beverage. The thermal barrier 12 is a coating comprising a mixture of an ink or paint with microspheres that expand when exposed to heat. The thermal barrier 12 may be printed or applied directly onto the cup. As an alternative, the barrier 12 may be applied as a sticker or label. The ink or paint is preferably water-based. An example of expanding microspheres is sold as the brand EXPANCEL®. When the microspheres are subjected to heat they expand in size. The EXPANCEL® microspheres include a polymer shell such as polyvinylidene chloride encapsulating a hydrocarbon such as isobutane. The particle size of the microspheres is 10-16 μm When the hydrocarbon is heated, the pressure in the shell rises and the thermoplastic shell soften, thereby permitting a volume of the microsphere to expand. When applied to a cup 10 as shown in FIG. 1, the provide enhanced thermal insulating properties so that a user can hold a cup containing hot contents without discomfort. While the present example uses EXPANCEL® microspheres, any other known or hereafter developed microspheres exhibiting similar characteristics may be alternatively used.

The heat used to expand the microspheres is derived from the hot fluid itself, for example, as it is poured into the cup. The number of microspheres per area of the cup covered may vary. For example, to provide an expanded thermal barrier 12 of constant thickness, a lower density of microspheres may be provided toward the bottom of the barrier. The bottom of the cup is exposed to heat first. When fewer microspheres are arranged near the bottom of the barrier, the barrier expands more uniformly. This could be achieved by applying bands of decreasing density from the top to the bottom of the barrier. FIG. 3 shows three bands 12a, 12b, 12c with upper band 12a having the greatest density and lower band 12c having the lowest density.

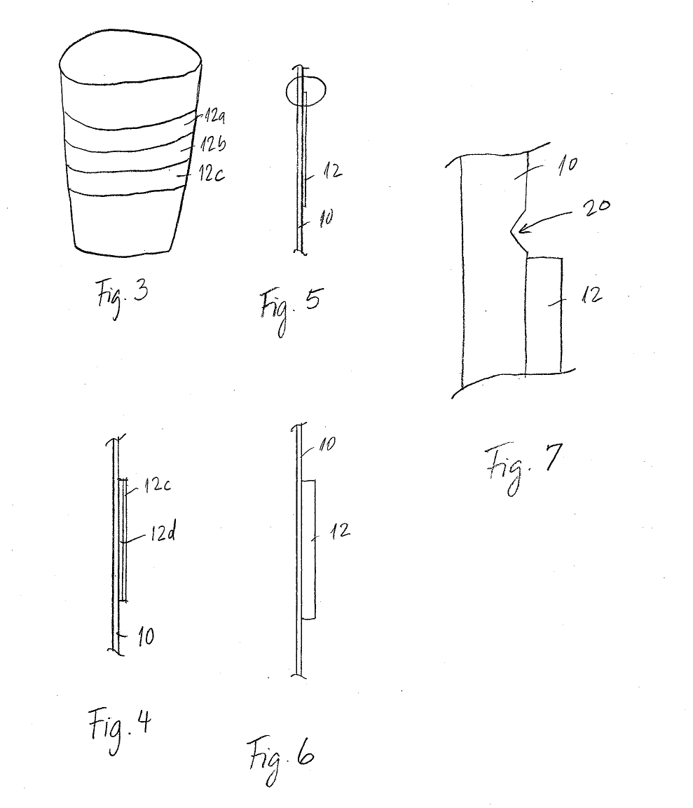

In another example shown in FIG. 4, a first layer 12d of the band having a relatively low density of microspheres is applied on the cup and a second layer 12c having a higher density of microspheres is applied onto the first layer. The first layer located closer to the cup is exposed to a greater heat. Alternatively, the layers could be reversed.

Alternatively or additionally, the properties of the microspheres in each layer may be different such that the outer layer 12c of the two layers expands at lower temperatures than the microspheres of the inner layer 12d. As a further alternative, the degree of expansion of the microspheres in the two different layers may be different so that the microspheres in the outer layer 12c expand to a greater extent than the microspheres in the inner layer 12d.

FIGS. 5 and 6 show cross sections of a wall of the cup 10 in the unexpanded and expanded states of the barrier 12, respectively. When the ink used to make the thermal barrier 12 is applied by the cup manufacturer, the microspheres have not expanded and the ink lies relatively flat on the surface of the cup 10 as shown in FIG. 5. In a preferred embodiment, prior to application of the barrier 12, a notch or channel 20 is etched or formed around the cup at the top and bottom borders of the barrier 12 as shown in FIG. 7. The notches prevent expansion of the ink above the top and bottom of the barrier. Since the barrier 12 is relatively flat when first applied and before use, the cups 10 can be stacked in a conventional manner for shipping without significantly adding to shipping volume. Upon arrival at a destination such as a store, the cups can remain stacked as is conventional until use.

When a user pours a hot beverage or food into the cup, the microspheres embedded in the ink are heated and expand. The microspheres generally expand in all directions. However, the notches or channels 20 limit the expansion at the top and bottom of the barrier 12 so that there is a clear boundary at the top and bottom boundaries of the barrier 12 as shown in FIG. 6. In a preferred embodiment, the barrier expands to a thickness of about on sixteenth of an inch to provide sufficient thermal insulation to protect the user from the heat of the contents. Accordingly, the user is provided a comfortable gripping area that extends around the cup 10.

The ink in which the microspheres are embedded is preferably hypoallergenic, recyclable, biodegradable and certified as safe for use in food service. As discussed in more detail below, the ink may comprise a latex paint. Furthermore, the ink may additionally comprise a thermo ink that changes color at approximately 60 degrees C. such as, for example, from white to brown to imitate a conventional cardboard sleeve.

In a preferred embodiment, the cup and the thermal barrier are both microwave safe. The thermal barrier 12 is preferably used on a paper cup. However, any hot beverage container such as, for example, ceramic or glass cups. In one embodiment, the microspheres contract back toward the unexpanded state after the heat is removed.

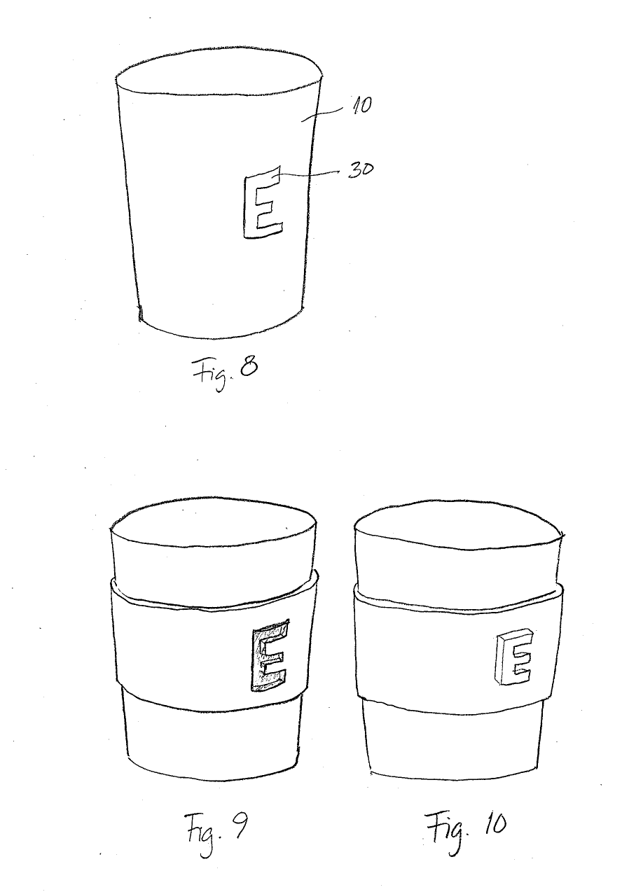

In a further embodiment, images, textures, art and/or logos may be designed to pop or expand more in certain area than others so that the images, textures, art, and/or logos appear when the microspheres reach their expanded state. This effect may be achieved by printing the image, texture, art or logo in a conventional ink or other material under the barrier layer 12 to produce a different porosity than the remainder of the cup surface. FIG. 8 shows an example of a pattern 30 in the shape of a letter E printed with conventional ink. Depending on the relative porosity, the barrier 12 may expand less than (FIG. 9) or more than (see FIG. 10) the rest of the barrier layer 12 in the area above the pattern 30. Alternatively or additionally, different color inks may be used in the barrier layer 12 to further differentiate the pattern 30 from the remainder of the barrier layer 12.

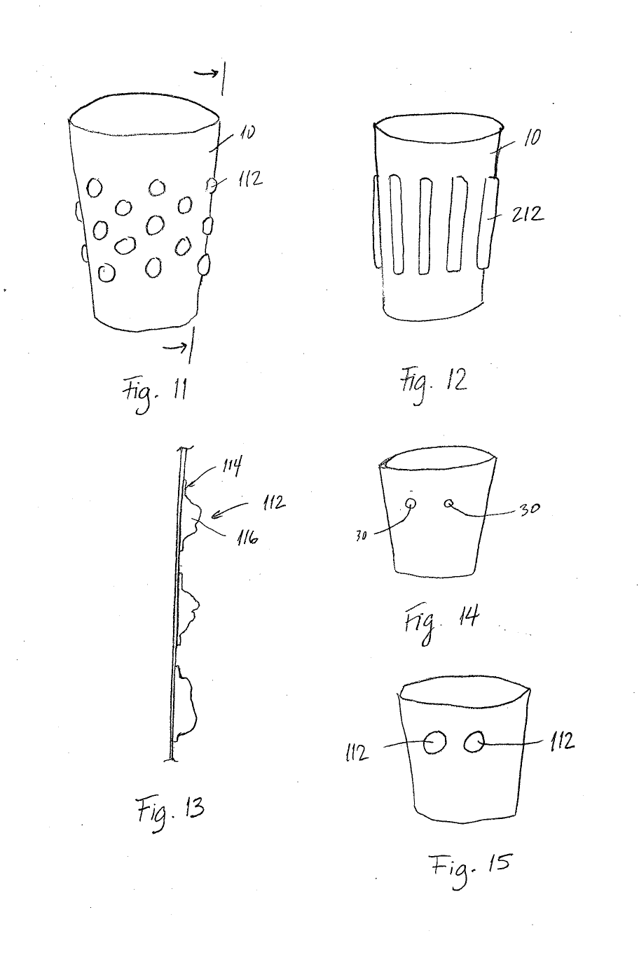

FIGS. 11 and 12 show further embodiments in which the barrier is not a continuous layer but a pattern of discrete islands, i.e., areas, of the mixture of the ink and the microspheres. More specifically, FIG. 11 shows a pattern of dots 112 and FIG. 12 shows a pattern of stripes 212, which create a corrugated pattern. In a particular embodiment of the invention, a portion of the dot 112 proximate the perimeter of the dot 112 does not expand as much as the center portion of the dot creating a blistering effect shown in FIG. 13. To produce this effect, an underlying ink is first printed on the cup 12 such as the ink 30 shown in FIG. 14 and the barrier layer dot 112 is then applied over the ink 30 such that the center of the dot is applied over an underlying ink and the perimeter of the dot is not applied over the ink 30. The dot 112 adheres to the cup much more strongly than it adheres to the ink 30. Upon expansion of the microcells in the barrier layer, the area of the dot 112 over the ink can lift away due to the expansion to create a blistering effect shown in FIG. 13. Although the particular embodiment in FIGS. 14-15 shows the ink 30 applied to the center area of the dot, it is possible for the ink to be applied only to the perimeter of the dot 112 if the ink has the effect of promoting adherence.

According to a further embodiment, the dots 112 or stripes 212 include a latex paint mixed with microcells. The latex paint is stretchable when it dries, thereby allowing the microcells to expand. In this embodiment, the edges of the dots or stripes tend to expand less than the centers thereof, thereby producing the blistering effect shown in FIG. 13.

The microspheres can be agitated to soften or weaken the cells before being mixed with the ink or paint to lower the trigger temperature. Using this method, applicants have achieved trigger temperatures of approximately 182 degrees F. To further lower the trigger temperature, the barrier may include a further compound or mixture that produces an exothermic reaction, i.e., the reaction that occurs in handwarmers, at a temperature lower than 182 degrees F. to heat the barrier to the trigger temperature of the microspheres. Preferably, the activation energy required for the exothermic reaction occurs at approximately 140-170 degrees F. or at 160-165 degrees F.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. In a container for holding a hot contents, a thermal barrier comprising a coating including a plurality of microspheres applied to an outer surface of the container, the microspheres being heat responsive in that the microspheres expand when exposed to a temperature at or exceeding a predetermined trigger temperature, from a flat state to an expanded state to form a thermal barrier between the hot contents and a user's hand, whereby a smaller volume of the thermal barrier in the flat state prior to exposure to the temperature at or exceeding the trigger temperature minimizes shipping and storing costs of the container.

2. The thermal barrier of claim 1, wherein the coating comprises one of an ink and a paint.

3. The thermal barrier of claim 1, wherein a degree of expansion of the microspheres is dependent on an underlying substrate, whereby variations in the underlying substrate are exhibited three dimensionally upon expansion of the thermal barrier.

4. The thermal barrier of claim 1, wherein a degree of expansion of the microspheres is dependent on a surface porosity of an underlying substrate, and wherein an area in the shape of a logo or design of the underlying substrate has a different surface porosity than a remainder of the underlying substrate, whereby the logo or design is exhibited three dimensionally upon expansion of the thermal barrier.

5. The thermal barrier of claim 4, wherein the different surface porosity is obtained by printing with an ink on the underlying surface in the area in the shape of a logo or design.

6. The thermal barrier of claim 1, wherein an area in the shape of a logo or design of the thermal barrier has a different color ink dye than a remaining portion of the thermal barrier.

7. The thermal barrier of claim 1, wherein a density of the microcells in the thermal barrier changes as a function of distance from an underlying substrate.

8. The thermal barrier of claim 1, wherein a density of the microcells in the thermal barrier changes as a function of location in the thermal barrier.

9. The thermal barrier of claim 1, wherein the plurality of microcells include two different microcells that exhibit different predetermined trigger temperatures.

10. The thermal barrier of claim 1, wherein the thermal barrier is a continuous band encircling the container.

11. The thermal barrier of claim 1, wherein the thermal barrier is applied as a plurality of discrete areas.

12. The thermal barrier of claim 1, wherein the ink is a thermo ink that changes color.

13. The thermal barrier of claim 1, further comprising a mixture or compound that produces an exothermic reaction that increases temperature in the barrier to the trigger temperature of the microspheres, wherein the activation energy required for the exothermic reaction occurs at a temperature lower than the trigger temperature.

14. A combination of a thermal barrier and a hot beverage container, the thermal barrier comprising a coating having a plurality of microspheres, the microspheres being heat responsive in that the microspheres expand when exposed to a temperature at or exceeding a predetermined trigger temperature, from a flat state to an expanded state to form a thermal barrier between the hot contents and a user's hand, whereby a smaller volume of the thermal barrier in the flat state prior to exposure to the temperature at or exceeding the trigger temperature minimizes shipping costs of the container.

15. The combination of claim 14, wherein the thermal barrier is a sticker or label that is attachable to the hot beverage container.
